(19) United States
(12) Patent Application Publication
(10) Pub. No.: US 2012/0075727 A1
(43) Pub. Date: Mar. 29, 2012

(54) IMAGING OPTICAL SYSTEM AND IMAGING APPARATUS

(75) Inventors: Yutaka TAKAKUBO, Saitama (JP); Eijiroh TADA, Saitama (JP); Koichi MARUYAMA, Tokyo (JP)

(73) Assignee: HOYA CORPORATION, Tokyo (JP)

(21) Appl. No.: 13/217,606

(22) Filed: Aug. 25, 2011

(30) Foreign Application Priority Data
Sep. 24, 2010 (JP) 2010-21452

(51) Int. Cl. G02B 5/04

(52) U.S. Cl. 359/737

(57) ABSTRACT

An imaging optical system, which is provided with an imaging lens group having at least one lens, an image side prism that bends light which has passed through the imaging lens group toward an image pickup device arranged at a predetermined position, and a cover glass that is provided for the image pickup device and lets the light bent by the image side prism pass therethrough, and wherein an exist surface of the image side prism from which the light bent by the image side prism emerges and an entrance surface of the cover glass are adhered to each other with an adhesive which is optically transparent.

The present invention relates to an imaging optical system, and an imaging apparatus having the imaging optical system.

Recently, digital cameras, digital video cameras and digital electronic devices in which an imaging module is mounted, such as a mobile phone, a PDA (Personal Digital Assistant), a PND (Portable Navigation Device), a PHS (Personal Handy phone System), a portable game machine and a notebook computer, have become widespread. Such cameras and digital electronic devices include a device in which an imaging optical system (a so-called bending optical system) configured to have an optical path elongated in a direction orthogonal to a direction of thickness of a device body is mounted so as to decrease the thickness of the device body. Hereafter, for convenience of explanation, the direction of thickness of a device body is referred to as “a case thickness direction”, and the direction orthogonal to the case thickness direction is referred to as “a case surface direction”.

Incidentally, when an optical path is directed to the case surface direction, a sensor surface of an image pickup chip needs to be positioned to be parallel with the case thickness direction so that an object image can be incident on the sensor surface of the image pickup chip. However, since an outer dimension of the image pickup chip in the sensor surface direction is large, it becomes difficult to design a device body case to be thin when the sensor surface is positioned to be parallel with the case thickness direction.

Each of Japanese Patent Provisional Publications No. 2006-058840A, No. 2006-154702A, No, 2007-033819A, No. 2004-247887A, No. 2007-316528A and 2008-268700A discloses an imaging optical system configured to decrease the dimension in the case thickness direction by positioning a sensor surface of an image pickup chip to be parallel with the case surface direction. Specifically, in the imaging optical system disclosed in these publications, a prism is arranged immediately before the image pickup chip and an optical path is bent to the case thickness direction.

### SUMMARY OF THE INVENTION

In the imaging optical system disclosed in each of the above described publications, the prism is located immediately before the image pickup chip. Therefore, unwanted light not contributing to normal image formation is caused, and the unwanted light appears on an image as a ghost or flare. The ghost or flare may result in an unintended image or decreasing of the contrast. That is, the ghost or flare deteriorates the image quality. As effective measures for suppressing occurrence of a ghost or flare, one might consider arranging a shield mask on an optical path between an optical element causing the unwanted light and the image pickup chip. However, in the configuration of the imaging optical system disclosed in the above described publications, it is difficult to arrange a shield mask between the image pickup chip and the prism located immediately before the image pickup chip. In addition, it might be impossible to sufficiently suppress the unwanted light by only arranging the shield mask, and therefore it might become impossible to avoid deterioration of the quality of an image even when the shield mask is arranged.

The present invention is advantageous in that it provides an imaging optical system and an imaging apparatus capable of decreasing the thickness of the imaging apparatus while preventing occurrence of unwanted light by a prism located immediately before an image pickup chip.

According to an aspect of the invention, there is provided an imaging optical system, which is provided with an imaging lens group having at least one lens, an image side prism that bends light which has passed through the imaging lens group toward an image pickup device arranged at a predetermined position, and a cover glass that is provided for the image pickup device and lets the light bent by the image side prism pass therethrough. In this configuration, an exit surface of the image side prism from which the light bent by the image side prism emerges and an entrance surface of the cover glass are adhered to each other with an adhesive which is optically transparent.

According to the above descried configuration, with respect to light proceeding from the inside of the image side prism to the outside, the critical angle is larger than that defined when an adhesion layer is not provided (i.e., when a air layer is provided between the image side prism and the cover glass). As a result, the amount of light totally reflecting from the exit surface decreased. When the refractive index of the adhesion layer is larger than the refractive index of the image side prism, total reflection does not occur. That is, in the imaging optical system, the light which totally reflects from the exit surface decreases or no light totally reflects from the exit surface. As a result, occurrence of a ghost or flare can be effectively suppressed even when the imaging optical system is formed as a so-called bending optical system which is advantageous in regard to decreasing of the thickness of the imaging optical system. Furthermore, since the image side prism and the cover glass are adhered to each other with an adhesion, it is possible to easily position the imaging optical system with respect to the image pickup device with a high degree of accuracy.

In at least one aspect, when n₁ represents a refractive index of the image side prism, n₂ represents a refractive index of an adhesion layer of the adhesive between the image side prism and the cover glass, and n₃ represents a refractive index of the cover glass, n₁, n₂ and n₃ may satisfy a following condition (1):

n₁≦n₂≦n₃ (1).

With this configuration, the total reflection does not occur on any of the exit surface of the image side prism and an entrance surface of the cover glass. Therefore, occurrence of a ghost or flare can be suppressed more effectively.

In at least one aspect, when n₁ represents a refractive index of the image side prism and n₂ represents a refractive index of an adhesion layer of the adhesive between the image side prism and the cover glass, n₁ and n₂ may satisfy a following condition (2):

n₁−n₂<0.02 (2).

With this configuration, the total reflection does not actually occur on the exit surface of the image side prism. Therefore, occurrence of a ghost or flare can be suppressed more suitably.

In at least one aspect, when n₂ represents a refractive index of an adhesion layer of the adhesive between the image side prism and the cover glass and n₃ represents a refractive index of the cover glass, n₂ and n₃ may satisfy a following condition (3):

n₂−n₃<0.07 (3).

With this configuration, the total reflection does not actually occur on the entrance surface of the cover glass. Therefore, occurrence of a ghost or flare can be suppressed more suitably.

According to another aspect of the invention, there is provided an imaging optical system, which is provided with an imaging lens group having at least one lens, an image side prism that bends light which has passed through the imaging lens group toward an image pickup device arranged at a predetermined position, and a cover glass that is provided for the image pickup device and lets the light bent by the image side prism pass therethrough. In this configuration, the image side prism and the cover glass are integrally formed as an integrated component.

With this configuration, it is possible to provide an imaging optical system capable of decreasing the thickness of an imaging apparatus while preventing occurrence of unwanted light by a prism located immediately before an image pickup chip.

In the above described imaging optical systems, the image side prism may bend an optical path by approximately 90°.

In at least one aspect, the imaging optical system may further include an object side prism located on an object side with respect to the image side prism, the object side prism being arranged such that at least one lens of lenses of the imaging lens group is located between the object side prism and the image side prism.

In at least one aspect, the object side prism may bend an optical path by approximately 90°.

According to another aspect of the invention, there is provided an imaging apparatus, which is provided with one of the above described imaging optical systems, and an image pickup device.

With this configuration, it is possible to provide an imaging apparatus capable of decreasing the thickness of the imaging apparatus while preventing occurrence of unwanted light by a prism located immediately before an image pickup chip.

### BRIEF DESCRIPTION OF THE ACCOMPANYING DRAWINGS

FIGS. 1A and 1B illustrate a configuration of an imaging apparatus according to an embodiment of the invention.

FIG. 2 illustrates a configuration of a conventional imaging apparatus.

FIG. 3 illustrates a configuration of an imaging optical system according to a first example.

FIG. 4 illustrates a configuration of an imaging optical system according to a second example.

FIG. 5 illustrates a configuration of an imaging optical system according to a third example.

FIG. 6 illustrates a configuration of an imaging optical system according to a fourth example.

FIG. 7 illustrates a configuration of an imaging optical system according to a fifth example.

### DETAILED DESCRIPTION OF THE EMBODIMENTS

Hereinafter, an embodiment according to the invention is described with reference to the accompanying drawings.

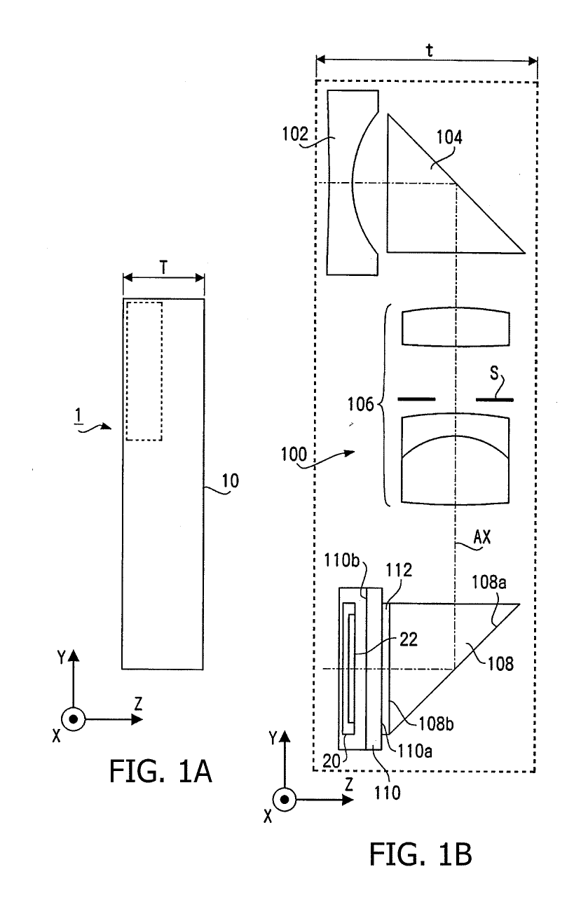

FIGS. 1A and 1B illustrate a configuration of an imaging apparatus 1 according to the embodiment of the invention. In FIGS. 1A and 1B, an optical configuration of the imaging apparatus 1 (i.e., a substantial part of the embodiment) is illustrated, and a mechanical configuration and a circuit configuration which are not substantial parts of the embodiment are omitted for the sake of simplicity. In this embodiment, the imaging apparatus 1 is, for example, a mobile phone. However, in another embodiment, the imaging apparatus 1 may be a digital camera, a digital video camera or a digital electronic device in which an imaging module is mounted, such as a mobile phone, PDA, PND, PHS, a portable game machine and a notebook computer. Alternatively, the imaging apparatus 1 may be an imaging module.

As shown in FIG. 1A, the imaging apparatus 1 includes a case 10 having a thickness T. In FIG. 1A, for convenience of explanation, the direction of the thickness T of the case 10 is defined as a Z axis direction, and two directions which are perpendicular to the Z axis direction and are perpendicular to each other are defined as a X axis direction (perpendicular to a paper face of FIGS. 1A and 1B) and a Y axis direction (parallel with the paper face of FIGS. 1A and 1B). An internal block diagram of a box indicated by a dashed line in FIG. 1A is illustrated in FIG. 1B. As shown in FIG. 1B, the imaging apparatus 1 includes an imaging optical system 100. The imaging optical system 100 includes an objective lens 102, an object side prism 104, an imaging lens group 106, an image side prism 108 and a cover glass 110. Each of the object side prism 104 and the image side prism 108 is a right angle prism configured to bend an optical path by 90°. In the imaging lens group 106, an aperture stop S is arranged. In FIG. 1B, a chain line represents an optical axis AX of the imaging optical system 100.

Light proceeding in the Z axis direction (i.e., the case thickness direction) from an object is incident on the objective lens 102 and is bent toward the Y axis direction (i.e., the case surface direction) by the object side prism 104. Then, the light passes through the imaging lens group 106, and is bent again toward the Z axis direction by a reflection surface 108a of the image side prism 108. The light which has reflected from the reflection surface 108a passes through an exit surface 108b of the image side prism 108, and passes through the cover glass 110. The cover glass 110 seals an image pickup chip 20 adhered to a resin package. The light which has passed through the cover glass 100 is incident, within an effective pixel area of a sensor surface 22, on the sensor surface 22 of the image pickup chip 20. The image pickup chip 20 is arranged such that the sensor surface 22 is parallel with the XY plane so as to let the light bent toward the Z axis direction by the reflection surface 108a be perpendicularly incident on the affective pixel area of the sensor surface 22. By thus arranging the image pickup chip 20 having a larger dimension in the sensor surface direction, it becomes possible to decrease, in the Z axis direction, the dimension t of a block including the imaging optical system 100 and the image pickup chip 20. As a result, the thickness T of the case 10 can be decreased, and the imaging apparatus 1 can be formed to be thin.

The image pickup chip 20 is, for example, a single-chip color CMOS (Complementary Metal Oxide Semiconductor) image sensor having a bayer layout. The sensor surface 22 of the image pickup chip 20 is located on an image plane of the imaging lens group 106. The image pickup chip 20 accumulates, at each pixel, charges responsive to a light amount of an optical image formed on the sensor surface 22, and converts the charges into an image signal. The image signal is input to an image processing engine (not shown). The image processing engine executes various types of image processing, such as, generating an image by processing the image signal, displaying the generated image and recording the generated image in a recording medium. The image pickup chip 20 is not limited to the CMOS sensor chip, and various types of image pickup chips (e.g., a CCD (Charge Couple Device) image sensor chip) may be used as the image pickup chip 20.

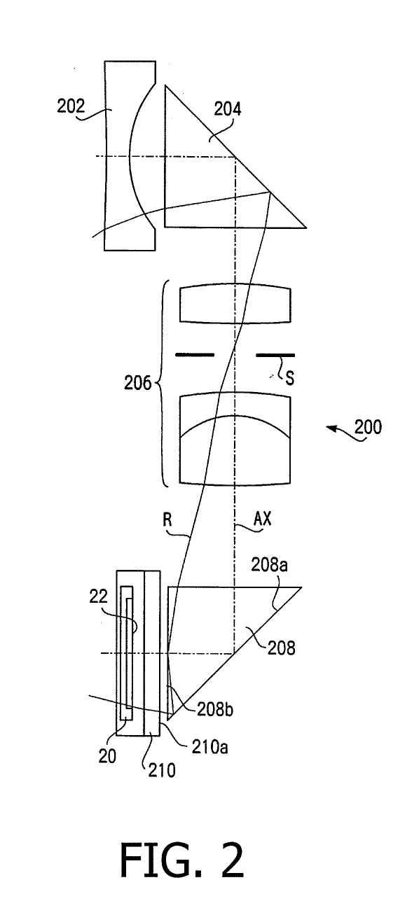

Incidentally, with regard to an optical path between the image side prism 108 and the image pickup chip 20, there is no space for arranging a mask for blocking only the unwanted light without blocking normal light contributing to the normal image formation. Therefore, there is a concern that the unwanted light caused by the image side prism 108 appears on the image as a ghost or flare and thereby deteriorates the quality of the image. FIG. 2 is an explanatory illustration for explaining an example of a ghost or flare caused by unwanted light in a conventional imaging optical system 200. In FIG. 2, a light ray R is on the outside of the maximum field angle (hereafter, light on the outside of the maximum field angle is simply referred to as “light outside the field angle”), and, according to a design condition, the light ray R is not incident on the effective pixel area of the sensor surface 22. In FIG. 2 showing the conventional imaging optical system 200, to elements which are substantially the same as those of the embodiment, the same reference numbers are assigned and explanations thereof will not be repeated.

The conventional imaging optical system 200 shown in FIG. 2 includes an objective lens 202, an object side prism 204, an imaging lens group 206, an image side prism 208 and a cover glass 210. The light ray R is incident on the objective lens 202 and is bent by the object side prism 204 by 90°. Then, the light ray R is incident on the image side prism 208 after passing through the imaging lens group 206. The light ray R is incident on an exit surface 208b of the image side prism 208. An incident angle of the light ray R with respect to the exit surface 208b is large, and is larger than or equal to a critical angle. Therefore, the light ray R totally reflects from the exit surface 208b. The light ray R which has totally reflected from the exit surface 208b is incident on a reflection surface 208a of the image side prism 208. Then, the light ray R passes through the exit surface 208b after totally reflecting again from the reflection surface 208a. Then, the light ray R passes through the cover glass 210, and is incident on the sensor surface 22 within an effective pixel area of the sensor surface 22. As described above, in the conventional imaging optical system 200, the light outside the field angle which has totally reflected from the reflection surface 208b appears on an image as a ghost or flare, and thereby deteriorates the quality of the image.

In the imaging optical system 100 according to the embodiment, the exit surface 108b of the image side prism 108 is adhered to an entrance surface e110a of the cover glass 110 in order to suppress occurrence of such a ghost or flare. An adhesion layer 112 between the image side prism 108 and the cover glass 110 is made of an adhesion which is optically transparent, and has a refractive index larger than that of air. Therefore, with respect to light proceeding from the inside of the image side prism 108 to the outside, the critical angle is larger than that defined when the adhesion layer 112 is not provided (i.e., when a air layer is provided between the image side prism 108 and the cover glass 110). As a result, the amount of light totally reflecting from the exit surface 108b decreased. When the refractive index of the adhesion layer 112 is larger than the refractive index of the image side prism 108, total reflection does not occur on the exit surface 108b. That is, in the imaging optical system 100 according to the embodiment, the light which totally reflects from the exit surface 108b decreases or no light totally reflects from the exit surface 108b. As a result, occurrence of a ghost or flare can be effectively suppressed. Furthermore, since the image side prism 108 and the cover glass 110 are adhered to each other with an adhesion, it is possible to easily position the imaging optical system 100 with respect to the sensor surface 22 with a high degree of accuracy.

When n₁ represents the refractive index of the image side prism 108, n₂ represents the refractive index of the adhesion layer 112, and n₃ represents the refractive index of the cover glass 100, the imaging optical system 100 may be configured to satisfy the following condition (1).

n₁≦n₂≦n₃ (1)

By satisfying the condition (1), the total reflection does not occur on any of the exit surface e108b of the image side prism 108 and the entrance surface 110a of the cover glass 110. As a result, occurrence of a ghost or flare can be effectively suppressed.

As the difference in refractive index between the image side prism 108 and the outside of the image side prism 108 decreases, the amount of light totally reflecting from the exit surface 108b becomes smaller. Therefore, the advantages of the present invention can also be achieved by choosing an adhesion having a refractive index smaller than that of the image side prism 108 because the refractive index of the adhesive is larger than that of air. For example, when n₁ and n₂ have a relationship satisfying the following condition (2), the light that could reach the image side prism 108 from the objective lens 102 does not actually cause the total reflection on the exit surface 108b of the image side prism 108. Therefore, occurrence of a ghost or flare on the image can be effectively suppressed.

n₁−n₂<0.02 (2)

When the condition (2) is not satisfied, the total reflection is caused on the exits surface 108b, and a ghost or flare becomes easily to occur.

When n₁ and n₂ have a relationship satisfying the following condition (3), the light that could reach the image side prism 108 from the objective lens 102 does not actually cause the total reflection on the entrance surface 110a of the cover glass 110. As a result, occurrence of a ghost or flare on the image can be effectively suppressed.

n₂−n₃<0.07 (3)

Hereafter, five concrete numeric examples (first to five examples) of the imaging optical system 100 installed in the above described imaging apparatus 1 are explained, and, as a comparative example, the conventional imaging optical system 200 is explained. The imaging optical system 100 according to each of the first to five examples has a common configuration on the object side with respect to the image side prism 108 as shown in FIG. 1. Therefore, in the following, only the optical configuration after the image side prism 108 is explained for the sake of simplicity. In the drawings for explaining the first to five examples, to elements which are substantially the same as those of the embodiment, the same reference numbers are assigned and explanation thereof will not be repeated.

### First Example

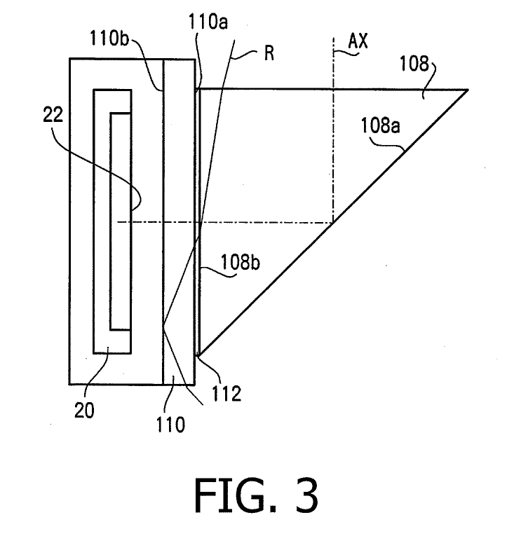

FIG. 3 illustrates a configuration of the imaging optical system 100 according to the first example. Table 1 shows a numeric configuration (design values) of the imaging optical system 100 according to the first example. In Table 1, “R” denotes the curvature radius (unit: mm) of each optical surface, “D” denotes the thickness of an optical component or the distance (unit: mm) from each optical surface to the next optical surface on the optical axis AX, “Nd” represents the refractive index at a d-line (the wavelength of 588 nm). The definitions regarding Tables and drawings of the first example are also applied to the following examples and the comparative example. In each of the first to fifth examples and the comparative example, each of the imaging lens groups 106 and 206 has the focal length of 4.0 mm, and the maximum image height in a cross sectional plane (YZ plane) in which the optical path is bent by the image side prism (108 or 208) is 2.45 mm.

TABLE 1

| Surface No. | R | D | Nd | Comments |
|---|---|---|---|---|
| 1 | −38.947 | 0.700 | 1.58913 | Objective Lens 102 |
| 2 | 3.451 | 1.030 | 1.00000 | |
| 3 | ∞ | 2.100 | 1.74400 | Object Side Prism 104 |
| 4 | ∞ | 2.100 | | |
| 5 | ∞ | 1.649 | 1.00000 | |
| 6 | 9.010 | 1.193 | 1.84666 | Imaging Lens Group 106 |
| 7 | −26.650 | 0.894 | 1.00000 | |
| 8 | ∞ | 1.167 | | |
| (Aperture Stop) | | | | |
| 9 | 10.422 | 0.700 | 1.84666 | |
| 10 | 2.221 | 2.123 | 1.77250 | |
| 11 | −12.176 | 3.174 | 1.00000 | |
| 12 | ∞ | 2.000 | 1.58913 | Image Side Prism 108 |
| 13 | ∞ | 2.000 | | |
| 14 | ∞ | 0.050 | 1.67003 | |
| 15 | ∞ | 0.500 | 1.69680 | Cover Glass 110 |
| 16 | ∞ | 0.300 | 1.00000 | |
| 17 | ∞ | | | Sensor Surface 22 |

### Second Example

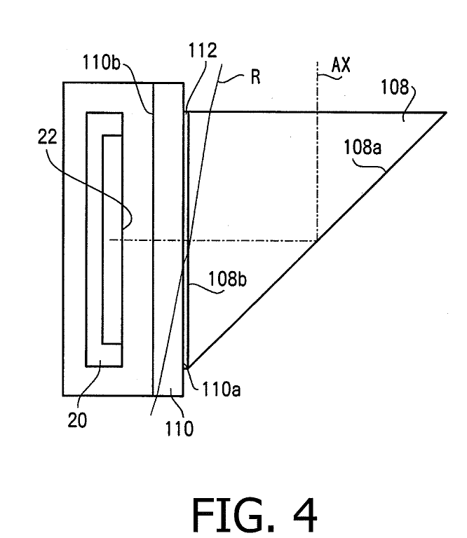

FIG. 4 illustrates a configuration of the imaging optical system 100 according to the second example. Table 2 shows a numeric configuration (design values) of the imaging optical system 100 according to the second example. In Table 2 (and in similar tables in the following examples and the comparative example), surfaces #1 to #10 have the same numeric values as those of the surfaces #1 to #10 in Table 1, and therefore explanations thereof will not be repeated for the sake of simplicity.

TABLE 2

| Surface No. | R | D | Nd | Comments |
|---|---|---|---|---|
| 11 | −12.176 | 3.155 | 1.00000 | |
| 12 | ∞ | 2.000 | 1.58913 | Image Side Prism 108 |
| 13 | ∞ | 2.000 | | |
| 14 | ∞ | 0.050 | 1.58144 | |
| 15 | ∞ | 0.500 | 1.60311 | Cover Glass 110 |
| 16 | ∞ | 0.300 | 1.00000 | |
| 17 | ∞ | | | Sensor Surface 22 |

### Third Example

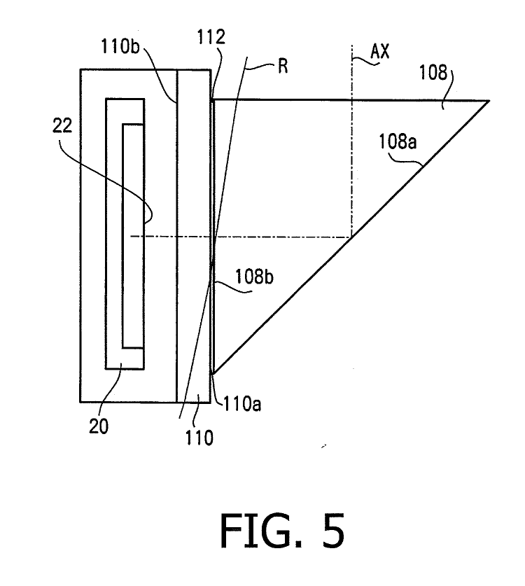

FIG. 5 illustrates a configuration of the imaging optical system 100 according to the third example. Table 3 shows a numeric configuration (design values) of the imaging optical system 100 according to the third example.

TABLE 3

| Surface No. | R | D | Nd | Comments |
|---|---|---|---|---|
| 11 | −12.176 | 3.157 | 1.00000 | |
| 12 | ∞ | 2.000 | 1.58913 | Image Side Prism 108 |
| 13 | ∞ | 2.000 | | |
| 14 | ∞ | 0.050 | 1.67003 | |
| 15 | ∞ | 0.500 | 1.60311 | Cover Glass 110 |
| 16 | ∞ | 0.300 | 1.00000 | |
| 17 | ∞ | | | Sensor Surface 22 |

### Fourth Example

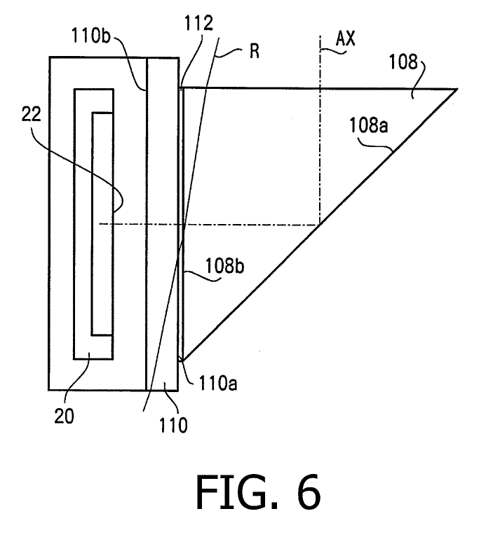

FIG. 6 illustrates a configuration of the imaging optical system 100 according to the fourth example. Table 4 shows a numeric configuration (design values) of the imaging optical system 100 according to the fourth example.

TABLE 4

| Surface No. | R | D | Nd | Comments |
|---|---|---|---|---|
| 11 | −12.176 | 3.209 | 1.00000 | |
| 12 | ∞ | 2.000 | 1.62299 | Image Side Prism 108 |
| 13 | ∞ | 2.000 | | |
| 14 | ∞ | 0.050 | 1.61272 | |
| 15 | ∞ | 0.500 | 1.60738 | Cover Glass 110 |
| 16 | ∞ | 0.300 | 1.00000 | |
| 17 | ∞ | | | Sensor Surface 22 |

### Fifth Example

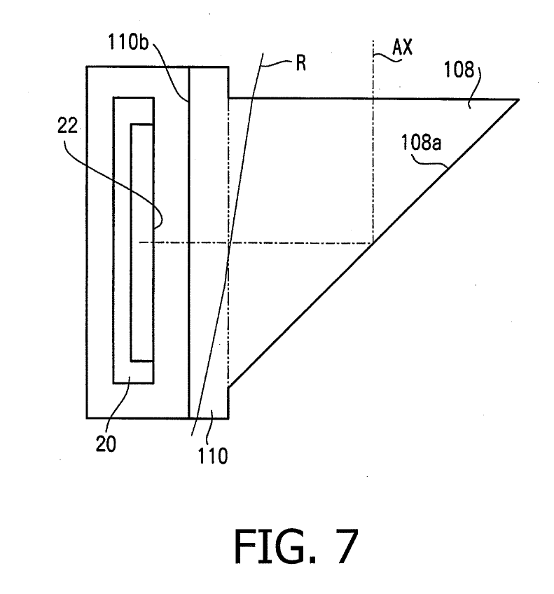

FIG. 7 illustrates a configuration of the imaging optical system 100 according to the fifth example. Table 5 shows a numeric configuration (design values) of the imaging optical system 100 according to the fifth example. In the imaging optical system 100 according to the fifth example, the image side prism 108 and the cover glass 110 are integrally formed as an integrated component in place of adhering the image side prism 108 to the cover glass 110. In FIG. 7, for convenience of explanation, a rightward portion of the integrated component with respect to a double chain line is assigned a numeric reference 108 and a leftward portion of the integrated component with respect to the double chain line is assigned a numeric reference 110.

TABLE 5

| Surface No. | R | D | Nd | Comments |
|---|---|---|---|---|
| 11 | −12.176 | 3.436 | 1.00000 | |
| 12 | ∞ | 2.000 | 1.74000 | Image Side Prism 108 |
| 13 | ∞ | 2.000 | | |
| 14 | ∞ | 0.500 | | Image Side Prism 108 |
| 15 | ∞ | 0.300 | 1.00000 | Cover Glass 110 |
| 16 | ∞ | | | Sensor Surface 22 |

### Comparative Example

The imaging optical system 200 according to the comparative example has the configuration shown in FIG. 2. Table 6 shows a numeric configuration (design values) of the imaging optical system 200 according to the comparative example. In the imaging optical system 200 according to the comparative example, the image side prism 208 is not adhered to the cover glass 210, and the image side prism 208 and the cover glass 210 are fixed independently. Specifically, the image side prism 208 is adhered to a lens holder (not shown), and the cover glass 210 is adhered to a resin package mounted on a circuit board. Between the exit surface 208b of the image side prism 208 and the entrance surface 210a of the cover glass 210, an air space is formed.

TABLE 6

| Surface No. | R | D | Nd | Comments |
|---|---|---|---|---|
| 11 | −12.176 | 3.004 | 1.00000 | |
| 12 | ∞ | 2.000 | 1.58913 | Image Side Prism 108 |
| 13 | ∞ | 2.000 | | |
| 14 | ∞ | 0.200 | 1.00000 | |
| 15 | ∞ | 0.500 | 1.69680 | Cover Glass 110 |
| 16 | ∞ | 0.300 | 1.00000 | |
| 17 | ∞ | | | Sensor Surface 22 |

Since the imaging optical system 200 according to the comparative example has a large difference in refractive index between the image side prism 208 and the outside medium (air), the total reflection is easily caused on the exit surface 208b. Therefore, deterioration of the quality of an image by a ghost or flare is caused easily. For example, as shown in FIG. 2, in the comparative example, the light ray R is totally reflected from the exit surface 208b, and then is totally reflected again on the reflection surface 208a, and enters the effective pixel area on the sensor surface 22. That is, in the comparative example, the light ray R appears on the image as a ghost or flare.

In the imaging optical system 100 according to each of the first to fourth examples, since the exit surface 108b of the image side prism 108 is adhered to the entrance surface 110a of the cover glass 110, the difference in refractive index between the image side prism 108 and the outside medium (the adhesion layer 112) is small. Since the critical angle on the exit surface 108b is large, the amount of light totally reflecting from the exit surface 108b decreases, and thereby a ghost or flare becomes hard to appear.

According to the first example, the condition (1) is satisfied. In the first example, since the total reflection does not occur on any of the exit surface 108b of the image side prism 108 and the entrance surface 110a of the cover glass 110, occurrence of a ghost or flare can be suppressed suitably. For example, as shown in FIG. 3, in the first example, the light ray R passes through the exit surface 108b and the entrance surface 110a in this order, reflects totally from the exit surface 110b of the cover glass 110 (i.e., a boundary between the cover glass 110 and an air space in the resin package), and proceeds to the outside of the effective pixel area on the sensor surface 22. The exit surface 110b is away from the reflection surface 108a of the image side prism 108. Therefore, the light totally reflecting from the exit surface 110b is not incident on the reflection surface 108a, and does not appear as a ghost or flare on the image. The same thing applies to the other examples.

In the second and third examples, the conditions (2) and (3) are satisfied respectively. In the fourth example, both of the conditions (2) and (3) are satisfied. For example, as shown in FIGS. 4 to 6, in the second to fourth examples, the light ray R passes through the exit surface 108b and the entrance surface 110a in this order, and proceeds to the outside of the effective pixel area on the sensor surface 22. That is, in the second to fourth examples, the light ray R does not appear on the image as a ghost or flare.

Although the present invention has been described in considerable detail with reference to certain preferred embodiments thereof, other embodiments are possible.

For example, the object side prism 104 may be substituted by a minor serving to bend an optical path. The object side prism 104 may not be arranged at the position on the object side with respect to the imaging lens group 106. For example, the object side prism 104 may be arranged at a position between lenses constituting the imaging lens group 106.

This application claims priority of Japanese Patent Application No. P2010-214152, filed on Sep. 24, 2010. The entire subject matter of the application is incorporated herein by reference.

What is claimed is:

1. An imaging optical system, comprising:
an imaging lens group having at least one lens;
an image side prism that bends light which has passed through the imaging lens group toward an image pickup device arranged at a predetermined position; and
a cover glass that is provided for the image pickup device and lets the light bent by the image side prism pass therethrough,
wherein an exist surface of the image side prism from which the light bent by the image side prism emerges and an entrance surface of the cover glass are adhered to each other with an adhesive which is optically transparent.

2. The imaging optical system according to claim 1,
wherein when n₁ represents a refractive index of the image side prism, n₂ represents a refractive index of an adhesion layer of the adhesive between the image side prism and the cover glass, and n₃ represents a refractive index of the cover glass, n₁, n₂ and n₃ satisfy a following condition (1):
n₁≦n₂≦n₃ (1).

3. The imaging optical system according to claim 1,
wherein when n₁ represents a refractive index of the image side prism and n₂ represents a refractive index of an adhesion layer of the adhesive between the image side prism and the cover glass, n₁ and n₂ satisfy a following condition (2):
n₁−n₂<0.02 (2).

4. The imaging optical system according to claim 1,
wherein when n₂ represents a refractive index of an adhesion layer of the adhesive between the image side prism and the cover glass and n₃ represents a refractive index of the cover glass, n₂ and n₃ satisfy a following condition (3):
n₂−n₃<0.07 (3).

5. The imaging optical system according to claim 1, wherein the image side prism is formed to bends an optical path by approximately 90°.

6. The imaging optical system according to claim 1,
further comprising an object side prism located on an object side with respect to the image side prism, the object side prism being arranged such that at least one lens of lenses of the imaging lens group is located between the object side prism and the image side prism.

7. The imaging optical system according to claim 6, wherein the object side prism is formed to bends an optical path by approximately 90°.

8. An imaging optical system, comprising:
an imaging lens group having at least one lens;
an image side prism that bends light which has passed through the imaging lens group toward an image pickup device arranged at a predetermined position; and
a cover glass that is provided for the image pickup device and lets the light bent by the image side prism pass therethrough,
wherein the image side prism and the cover glass are integrally formed as an integrated component.

9. The imaging optical system according to claim 8, wherein the image side prism is formed to bend an optical path by approximately 90°.

10. The imaging optical system according to claim 8,
further comprising an object side prism located on an object side with respect to the image side prism, the object side prism being arranged such that at least one lens of lenses of the imaging lens group is located between the object side prism and the image side prism.

11. The imaging optical system according to claim 10, wherein the object side prism is formed to bend an optical path by approximately 90°.

12. An imaging apparatus, comprising:
an imaging optical system; and
an image pickup device,
wherein the imaging optical system comprises:
an imaging lens group having at least one lens;
an image side prism that bends light which has passed through the imaging lens group toward the image pickup device arranged at a predetermined position; and
a cover glass that is provided for the image pickup device and lets the light bent by the image side prism pass therethrough,
wherein an exist surface of the image side prism from which the light bent by the image side prism emerges and an entrance surface of the cover glass are adhered to each other with an adhesive which is optically transparent,
wherein the image pickup device is arranged such that a sensor surface of the image pickup device is positioned on an image plane of the imaging optical system.

13. The imaging apparatus according to claim 12,
wherein when n₁ represents a refractive index of the image side prism, n₂ represents a refractive index of an adhesion layer of the adhesive between the image side prism and the cover glass, and n₃ represents a refractive index of the cover glass, n₁, n₂ and n₃ satisfy a following condition (1):
n₁≦n₂≦n₃ (1).

14. The imaging apparatus according to claim 12,
wherein when n₁ represents a refractive index of the image side prism and n₂ represents a refractive index of an adhesion layer of the adhesive between the image side prism and the cover glass, n₁ and n₂ satisfy a following condition (2):
n₁−n₂<0.02 (2).

15. The imaging apparatus according to claim 12,
wherein when n₂ represents a refractive index of an adhesion layer of the adhesive between the image side prism and the cover glass and n₃ represents a refractive index of the cover glass, n₂ and n₃ satisfy a following condition (3):
n₂−n₃<0.07 (3).

16. The imaging apparatus according to claim 12, wherein the image side prism is formed to bend an optical path by approximately 90°.

17. The imaging apparatus according to claim 12,
wherein the imaging optical system further comprises an object side prism located on an object side with respect to the image side prism, the object side prism being arranged such that at least one lens of lenses of the imaging lens group is located between the object side prism and the image side prism.

18. The imaging apparatus according to claim 17, wherein the object side prism is formed to bend an optical path by approximately 90°.

19. An imaging apparatus, comprising:
an imaging optical system; and
an image pickup device,
wherein the imaging optical system comprises:
an imaging lens group having at least one lens;
an image side prism that bends light which has passed through the imaging lens group toward the image pickup device arranged at a predetermined position; and
a cover glass that is provided for the image pickup device and lets the light bent by the image side prism pass therethrough,
wherein the image side prism and the cover glass are integrally formed as an integrated component, and
wherein the image pickup device is arranged such that a sensor surface of the image pickup device is positioned on an image plane of the imaging optical system.

20. The imaging apparatus according to claim 19, wherein the image side prism is formed to bend an optical path by approximately 90°.

21. The imaging apparatus according to claim 19,
wherein the imaging optical system further comprises an object side prism located on an object side with respect to the image side prism, the object side prism being arranged such that at least one lens of lenses of the imaging lens group is located between the object side prism and the image side prism.

22. The imaging apparatus according to claim 21, wherein the object side prism is formed to bend an optical path by approximately 90°.
